(19) United States
(12) Patent Application Publication
(10) Pub. No.: US 2014/0007986 A1
(43) Pub. Date: Jan. 9, 2014

(54) COMPOSITES OF BULK AMORPHOUS ALLOY AND FIBER/WIRES

(71) Applicants: CHRISTOPHER D. PREST, San Francisco, CA (US); Joseph C. Poole, San Francisco, CA (US); Matthew S. Scott, Campbell, CA (US); Dermot J. Stratton, San Francisco, CA (US)

(72) Inventors: CHRISTOPHER D. PREST, San Francisco, CA (US); Joseph C. Poole, San Francisco, CA (US); Matthew S. Scott, Campbell, CA (US); Dermot J. Stratton, San Francisco, CA (US)

(21) Appl. No.: 13/541,705

(22) Filed: Jul. 4, 2012

(51) Int. Cl. B32B 15/04; C22C 45/00

(52) U.S. Cl. 148/516; 148/403

(57) ABSTRACT

A composite structure includes a matrix material having an intrinsic strain-to-failure rating in tension and a reinforcing material embedded in the bulk material. The reinforcing material is pre-stressed by a tensile force acting along one direction. The embedded reinforcing material interacts with the matrix material to place the composite structure into a compressive state. The compressive state provides an increased strain-to-failure rating in tension of the composite structure along a direction that is greater than the intrinsic strain-to-failure rating in tension of the matrix material along that direction. At least one of the matrix material and the reinforcing material is a bulk amorphous alloy (BAA). The reinforcing material can be a fiber or wire. In various embodiments, the matrix material may be a bulk amorphous alloy and/or the reinforcing material may be a bulk amorphous alloy.

### BACKGROUND

This disclosure relates to composite structures of bulk amorphous alloy and/or bulk metallic glass materials, or other bulk materials reinforced by fibers and/or wires to improve material strength, stress resistance, and other properties.

An amorphous metal is a metallic material with a disordered atomic-scale structure. In contrast to most metals, which are crystalline and therefore have a highly ordered arrangement of atoms, amorphous alloys are non-crystalline. Materials in which such a disordered structure is produced directly from the liquid state during cooling are called “glasses”, and so amorphous metals are commonly referred to as “metallic glasses” or “glassy metals”. The term glass is usually defined in a wide sense, to include every solid that possesses a non-crystalline (i.e., amorphous) structure and that exhibits a glass transition when heated towards the liquid state. In this wider sense, glasses can be made of quite different classes of materials: metallic alloys, ionic melts, aqueous solutions, molecular liquids, and polymers.

There are several ways besides extremely rapid cooling in which amorphous metals can be produced, including physical vapor deposition, solid-state reaction, ion irradiation, and mechanical alloying. Conventionally, small batches of amorphous metals have been produced through a variety of small-scale quick-cooling methods. For instance, amorphous metal wires have been produced by sputtering molten metal onto a spinning metal disk (melt spinning). The rapid cooling, on the order of millions of degrees a second, is too fast for crystals to form and the material is “locked in” a glassy state. More recently a number of alloys with critical cooling rates low enough to allow formation of amorphous structure in thick layers (over 1 mm) have been produced; these are known as bulk metallic glasses (BMG) or, alternatively, bulk amorphous alloys (BAA).

Amorphous alloys have a variety of potentially useful properties. In particular, they tend to be stronger than crystalline alloys of similar chemical composition, and they can sustain larger reversible (“elastic”) deformations than crystalline alloys. Amorphous metals derive their strength directly from their non-crystalline structure, which does not have any of the defects (such as dislocations) that limit the strength of crystalline alloys. However, metallic glasses at room temperature are not ductile and tend to fail suddenly when loaded in tension beyond about 1.0-1.5% strain-to-failure-without-yield, which can limit the material applicability in reliability-critical applications, as the impending failure is not evident.

Therefore, while amorphous alloy materials can provide acceptable material properties while under that influence of compressive forces, these materials are generally brittle, resulting in unacceptable tensile strength for some applications.

What is needed is a BAA composite structure with improved tensile strength that uses a BAA material as either a matrix material and/or a reinforcing material, and a method for making such a structure.

### SUMMARY

A proposed solution according to embodiments herein for nano- and micro-replication in metals is to use bulk-solidifying amorphous alloys as either a base material and/or as a tensile fiber embedded in the base material. The embodiments herein include methods for creating a composite structure with improved tensile strength.

In one embodiment, a composite structure includes a matrix material having an intrinsic strain-to-failure rating in tension associated therewith; and a reinforcing material embedded in the bulk material along a first direction, wherein the reinforcing material is pre-stressed in tension by a tensile force acting along the first direction; said pre-stressed embedded reinforcing material interacting with said matrix material so as to place said composite structure into a compressive state along said first direction, said compressive state providing an increased strain-to-failure rating in tension of the composite structure along the first direction that is greater than the intrinsic strain-to-failure rating in tension of the matrix material along the first direction, wherein at least one of the matrix material and the reinforcing material comprises a bulk amorphous alloy (BAA).

In one aspect of this embodiment, the matrix material comprises the BAA and the pre-stressed embedded reinforcing material comprises a pre-stressed ductile fiber or wire embedded in the BAA.

In another aspect of this embodiment, the matrix material comprises a bulk material and the pre-stressed embedded reinforcing material comprises the BAA shaped as a fiber or wire embedded in the matrix material. The bulk material may be selected from the group consisting of silica, ceramic, and a plastic material. Alternatively, the bulk material comprises a crystalline form of one or more metals or alloys of aluminum, bismuth, cobalt, copper, gallium, gold, indium, iron, lead, magnesium, mercury, nickel, potassium, plutonium, rare earth alloys, rhodium, silver, titanium, tin, uranium, zinc, zirconium, and mixtures thereof.

In one embodiment, a method for manufacturing a composite structure includes providing a matrix material having an intrinsic strain-to-failure rating in tension associated therewith; heating the matrix material to at least a glass transition temperature (T_{g}) thereof; after said heating, embedding reinforcing material in the matrix material along a first direction; providing a tensioning force along the first direction to ends of the reinforcing material so as to place the reinforcing material in tension and thereby enable an interaction between said reinforcing material and said matrix material; cooling the bulk amorphous alloy to a temperature less than T_{g}; after said cooling, releasing the tensioning force and thereby placing the composite structure into a compressive state along said first direction by the interaction between said reinforcing material and said matrix material, said compressive state providing an increased strain-to-failure rating in tension of the composite structure along the first direction that is greater than the intrinsic strain-to-failure rating in tension of the matrix material along the first direction, wherein at least one of said matrix material and said reinforcing material comprise a bulk amorphous alloy (BAA).

### BRIEF DESCRIPTION OF THE DRAWINGS

FIG. 1 provides a temperature-viscosity diagram of an exemplary bulk solidifying amorphous alloy;

FIG. 2 provides a schematic of a time-temperature-transformation (TTT) diagram for an exemplary bulk solidifying amorphous alloy;

FIG. 3 illustrates a composite structure of bulk material (e.g., bulk amorphous alloy or other bulk material) and ductile fiber/wire (e.g., a metal wire or BAA fiber) of one or more embodiments;

FIG. 4 illustrates another embodiment of a composite structure of bulk material (e.g., bulk amorphous alloy or other bulk material) and multiple ductile fibers/wires (e.g., metal wires or BAA fibers) of one or more embodiments;

FIG. 5 illustrates an exemplary fiber/wire with a series of ridges or ridged pattern arranged on an external surface;

FIG. 6 illustrates an exemplary fiber/wire with a helical pattern arranged on an external surface;

FIG. 7 illustrates a cross-section of an exemplary optical fiber of an embodiment;

FIG. 8 illustrates an exemplary embodiment of a composite structure of bulk material with multiple ductile fibers/wires and an electrical circuit embedded in the bulk material; and

FIG. 9 illustrates an exemplary flowchart of a method of manufacturing a composite structure of an embodiment.

### DETAILED DESCRIPTION

All publications, patents, and patent applications cited in this Specification are hereby incorporated by reference in their entirety.

The articles “a” and “an” are used herein to refer to one or to more than one (i.e., to at least one) of the grammatical object of the article. By way of example, “a polymer resin” means one polymer resin or more than one polymer resin. Any ranges cited herein are inclusive. The terms “substantially” and “about” used throughout this Specification are used to describe and account for small fluctuations. For example, they can refer to less than or equal to ±5%, such as less than or equal to ±2%, such as less than or equal to ±1%, such as less than or equal to ±0.5%, such as less than or equal to ±0.2%, such as less than or equal to ±0.1%, such as less than or equal to ±0.05%.

Bulk-solidifying amorphous alloys, or bulk metallic glasses (“BMG”), are a recently developed class of metallic materials. These alloys may be solidified and cooled at relatively slow rates, and they retain the amorphous, non-crystalline (i.e., glassy) state at room temperature. Amorphous alloys have many superior properties than their crystalline counterparts. However, if the cooling rate is not sufficiently high, crystals may form inside the alloy during cooling, so that the benefits of the amorphous state can be lost. For example, one challenge with the fabrication of bulk amorphous alloy parts is partial crystallization of the parts due to either slow cooling or impurities in the raw alloy material. As a high degree of amorphicity (and, conversely, a low degree of crystallinity) is desirable in BMG parts, there is a need to develop methods for casting BMG parts having controlled amount of amorphicity.

FIG. 1 (obtained from U.S. Pat. No. 7,575,040) shows a viscosity-temperature graph of an exemplary bulk solidifying amorphous alloy, from the VIT-001 series of Zr—Ti—Ni—Cu—Be family manufactured by Liquidmetal Technology. It should be noted that there is no clear liquid/solid transformation for a bulk solidifying amorphous metal during the formation of an amorphous solid. The molten alloy becomes more and more viscous with increasing undercooling until it approaches solid form around the glass transition temperature. Accordingly, the temperature of solidification front for bulk solidifying amorphous alloys can be around glass transition temperature, where the alloy will practically act as a solid for the purposes of pulling out the quenched amorphous sheet product.

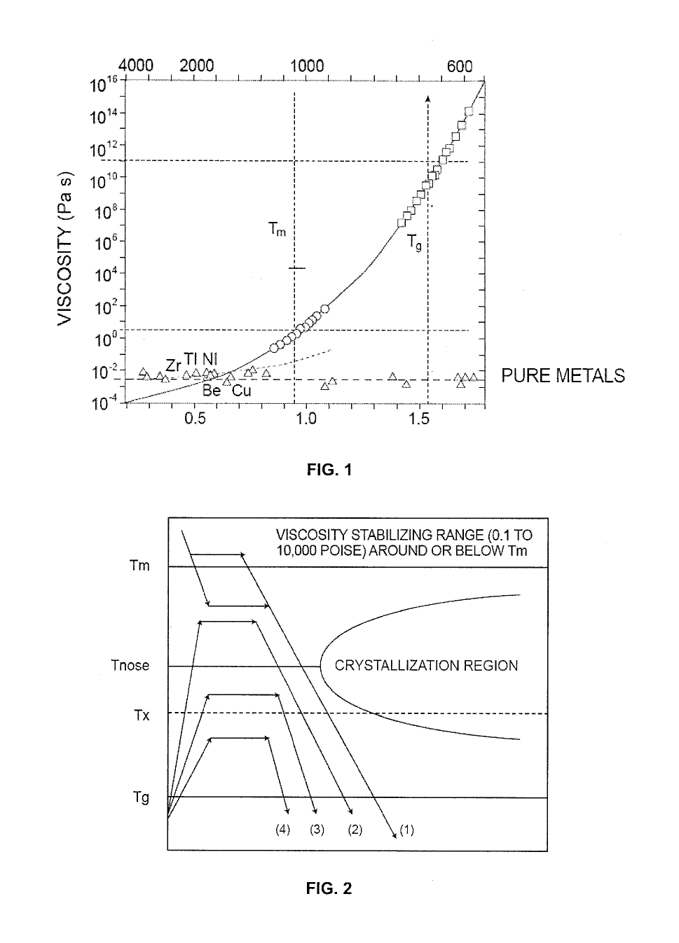

FIG. 2 (obtained from U.S. Pat. No. 7,575,040) shows the time-temperature-transformation (TTT) cooling curve of an exemplary bulk solidifying amorphous alloy, or TTT diagram. Bulk-solidifying amorphous metals do not experience a liquid/solid crystallization transformation upon cooling, as with conventional metals. Instead, the highly fluid, non crystalline form of the metal found at high temperatures (near a “melting temperature” Tm) becomes more viscous as the temperature is reduced (near to the glass transition temperature Tg), eventually taking on the outward physical properties of a conventional solid.

Even though there is no liquid/crystallization transformation for a bulk solidifying amorphous metal, a “melting temperature” Tm may be defined as the thermodynamic liquidus temperature of the corresponding crystalline phase. Under this regime, the viscosity of bulk-solidifying amorphous alloys at the melting temperature could lie in the range of about 0.1 poise to about 10,000 poise, and even sometimes under 0.01 poise. A lower viscosity at the “melting temperature” would provide faster and complete filling of intricate portions of the shell/mold with a bulk solidifying amorphous metal for forming the BMG parts. Furthermore, the cooling rate of the molten metal to form a BMG part has to such that the time-temperature profile during cooling does not traverse through the nose-shaped region bounding the crystallized region in the TTT diagram of FIG. 2. In FIG. 2, Tnose is the critical crystallization temperature Tx where crystallization is most rapid and occurs in the shortest time scale.

The supercooled liquid region, the temperature region between Tg and Tx is a manifestation of the extraordinary stability against crystallization of bulk solidification alloys. In this temperature region the bulk solidifying alloy can exist as a high viscous liquid. The viscosity of the bulk solidifying alloy in the supercooled liquid region can vary between 10¹² Pa s at the glass transition temperature down to 10⁵ Pa s at the crystallization temperature, the high temperature limit of the supercooled liquid region. Liquids with such viscosities can undergo substantial plastic strain under an applied pressure. The embodiments herein make use of the large plastic formability in the supercooled liquid region as a forming and separating method.

One needs to clarify something about Tx. Technically, the nose-shaped curve shown in the TTT diagram describes Tx as a function of temperature and time. Thus, regardless of the trajectory that one takes while heating or cooling a metal alloy, when one hits the TTT curve, one has reached Tx. In FIG. 1(b), Tx is shown as a dashed line as Tx can vary from close to Tm to close to Tg.

The schematic TTT diagram of FIG. 2 shows processing methods of die casting from at or above Tm to below Tg without the time-temperature trajectory (shown as (1) as an example trajectory) hitting the TTT curve. During die casting, the forming takes place substeantially simultaneously with fast cooling to avoid the trajectory hitting the TTT curve. The procssing methods for superplastic forming (SPF) from at or below Tg to below Tm without the time-temperature trajectory (shown as (2), (3) and (4) as example trajectories) hitting the TTT curve. In SPF, the amorphous BMG is reheated into the supercooled liquid region where the available processing window could be much larger than die casting, resulting in better controllability of the process. The SPF process does not require fast cooling to avoid crystallization during cooling. Also, as shown by example trajectories (2), (3) and (4), the SPF can be carried out with the highest temperature during SPF being above Tnose or below Tnose, up to about Tm. If one heats up a piece of amorphous alloy but manages to avoid hitting the TTT curve, you have heated “between Tg and Tm”, but one would have not reached Tx.

Typical differential scanning calorimeter (DSC) heating curves of bulk-solidifying amorphous alloys taken at a heating rate of 20 C/min describe, for the most part, a particular trajectory across the ITT data where one would likely see a Tg at a certain temperature, a Tx when the DSC heating ramp crosses the TTT crystallization onset, and eventually melting peaks when the same trajectory crosses the temperature range for melting. If one heats a bulk-solidifying amorphous alloy at a rapid heating rate as shown by the ramp up portion of trajectories (2), (3) and (4) in FIG. 2, then one could avoid the TTT curve entirely, and the DSC data would show a glass transition but no Tx upon heating. Another way to think about it is trajectories (2), (3) and (4) can fall anywhere in temperature between the nose of the TTT curve (and even above it) and the Tg line, as long as it does not hit the crystallization curve. That just means that the horizontal plateau in trajectories might get much shorter as one increases the processing temperature.

### Phase

The term “phase” herein can refer to one that can be found in a thermodynamic phase diagram. A phase is a region of space (e.g., a thermodynamic system) throughout which all physical properties of a material are essentially uniform. Examples of physical properties include density, index of refraction, chemical composition and lattice periodicity. A simple description of a phase is a region of material that is chemically uniform, physically distinct, and/or mechanically separable. For example, in a system consisting of ice and water in a glass jar, the ice cubes are one phase, the water is a second phase, and the humid air over the water is a third phase. The glass of the jar is another separate phase. A phase can refer to a solid solution, which can be a binary, tertiary, quaternary, or more, solution, or a compound, such as an intermetallic compound. As another example, an amorphous phase is distinct from a crystalline phase.

### Metal, Transition Metal, and Non-Metal

The term “metal” refers to an electropositive chemical element. The term “element” in this Specification refers generally to an element that can be found in a Periodic Table. Physically, a metal atom in the ground state contains a partially filled band with an empty state close to an occupied state. The term “transition metal” is any of the metallic elements within Groups 3 to 12 in the Periodic Table that have an incomplete inner electron shell and that serve as transitional links between the most and the least electropositive in a series of elements. Transition metals are characterized by multiple valences, colored compounds, and the ability to form stable complex ions. The term “nonmetal” refers to a chemical element that does not have the capacity to lose electrons and form a positive ion.

Depending on the application, any suitable nonmetal elements, or their combinations, can be used. The alloy (or “alloy composition”) can comprise multiple nonmetal elements, such as at least two, at least three, at least four, or more, nonmetal elements. A nonmetal element can be any element that is found in Groups 13-17 in the Periodic Table. For example, a nonmetal element can be any one of F, Cl, Br, I, At, O, S, Se, Te, Po, N, P, As, Sb, Bi, C, Si, Ge, Sn, Pb, and B. Occasionally, a nonmetal element can also refer to certain metalloids (e.g., B, Si, Ge, As, Sb, Te, and Po) in Groups 13-17. In one embodiment, the nonmetal elements can include B, Si, C, P, or combinations thereof. Accordingly, for example, the alloy can comprise a boride, a carbide, or both.

A transition metal element can be any of scandium, titanium, vanadium, chromium, manganese, iron, cobalt, nickel, copper, zinc, yttrium, zirconium, niobium, molybdenum, technetium, ruthenium, rhodium, palladium, silver, cadmium, hafnium, tantalum, tungsten, rhenium, osmium, iridium, platinum, gold, mercury, rutherfordium, dubnium, seaborgium, bohrium, hassium, meitnerium, ununnilium, unununium, and ununbium. In one embodiment, a BMG containing a transition metal element can have at least one of Sc, Y, La, Ac, Ti, Zr, Hf, V, Nb, Ta, Cr, Mo, W, Mn, Tc, Re, Fe, Ru, Os, Co, Rh, Ir, Ni, Pd, Pt, Cu, Ag, Au, Zn, Cd, and Hg. Depending on the application, any suitable transitional metal elements, or their combinations, can be used. The alloy composition can comprise multiple transitional metal elements, such as at least two, at least three, at least four, or more, transitional metal elements.

The presently described alloy or alloy “sample” or “specimen” alloy can have any shape or size. For example, the alloy can have a shape of a particulate, which can have a shape such as spherical, ellipsoid, wire-like, rod-like, sheet-like, flake-like, or an irregular shape. The particulate can have any size. For example, it can have an average diameter of between about 1 micron and about 100 microns, such as between about 5 microns and about 80 microns, such as between about 10 microns and about 60 microns, such as between about 15 microns and about 50 microns, such as between about 15 microns and about 45 microns, such as between about 20 microns and about 40 microns, such as between about 25 microns and about 35 microns. For example, in one embodiment, the average diameter of the particulate is between about 25 microns and about 44 microns. In some embodiments, smaller particulates, such as those in the nanometer range, or larger particulates, such as those bigger than 100 microns, can be used.

The alloy sample or specimen can also be of a much larger dimension. For example, it can be a bulk structural component, such as an ingot, housing/casing of an electronic device or even a portion of a structural component that has dimensions in the millimeter, centimeter, or meter range.

### Solid Solution

The term “solid solution” refers to a solid form of a solution. The term “solution” refers to a mixture of two or more substances, which may be solids, liquids, gases, or a combination of these. The mixture can be homogeneous or heterogeneous. The term “mixture” is a composition of two or more substances that are combined with each other and are generally capable of being separated. Generally, the two or more substances are not chemically combined with each other.

### Alloy

In some embodiments, the alloy composition described herein can be fully alloyed. In one embodiment, an “alloy” refers to a homogeneous mixture or solid solution of two or more metals, the atoms of one replacing or occupying interstitial positions between the atoms of the other; for example, brass is an alloy of zinc and copper. An alloy, in contrast to a composite, can refer to a partial or complete solid solution of one or more elements in a metal matrix, such as one or more compounds in a metallic matrix. The term alloy herein can refer to both a complete solid solution alloy that can give single solid phase microstructure and a partial solution that can give two or more phases. An alloy composition described herein can refer to one comprising an alloy or one comprising an alloy-containing composite.

Thus, a fully alloyed alloy can have a homogenous distribution of the constituents, be it a solid solution phase, a compound phase, or both. The term “fully alloyed” used herein can account for minor variations within the error tolerance. For example, it can refer to at least 90% alloyed, such as at least 95% alloyed, such as at least 99% alloyed, such as at least 99.5% alloyed, such as at least 99.9% alloyed. The percentage herein can refer to either volume percent or weight percentage, depending on the context. These percentages can be balanced by impurities, which can be in terms of composition or phases that are not a part of the alloy.

### Amorphous or Non-Crystalline Solid

An “amorphous” or “non-crystalline solid” is a solid that lacks lattice periodicity, which is characteristic of a crystal. As used herein, an “amorphous solid” includes “glass” which is an amorphous solid that softens and transforms into a liquid-like state upon heating through the glass transition. Generally, amorphous materials lack the long-range order characteristic of a crystal, though they can possess some short-range order at the atomic length scale due to the nature of chemical bonding. The distinction between amorphous solids and crystalline solids can be made based on lattice periodicity as determined by structural characterization techniques such as x-ray diffraction and transmission electron microscopy.

The terms “order” and “disorder” designate the presence or absence of some symmetry or correlation in a many-particle system. The terms “long-range order” and “short-range order” distinguish order in materials based on length scales.

The strictest form of order in a solid is lattice periodicity: a certain pattern (the arrangement of atoms in a unit cell) is repeated again and again to form a translationally invariant tiling of space. This is the defining property of a crystal. Possible symmetries have been classified in 14 Bravais lattices and 230 space groups.

Lattice periodicity implies long-range order. If only one unit cell is known, then by virtue of the translational symmetry it is possible to accurately predict all atomic positions at arbitrary distances. The converse is generally true, except, for example, in quasi-crystals that have perfectly deterministic tilings but do not possess lattice periodicity.

Long-range order characterizes physical systems in which remote portions of the same sample exhibit correlated behavior. This can be expressed as a correlation function, namely the spin-spin correlation function: G(x, x′)= [symbol] s(x), s(x′) [symbol] .

In the above function, s is the spin quantum number and x is the distance function within the particular system. This function is equal to unity when x=x′ and decreases as the distance |x−x′| increases. Typically, it decays exponentially to zero at large distances, and the system is considered to be disordered. If, however, the correlation function decays to a constant value at large |x−x′|, then the system can be said to possess long-range order. If it decays to zero as a power of the distance, then it can be called quasi-long-range order. Note that what constitutes a large value of |x−x′| is relative.

A system can be said to present quenched disorder when some parameters defining its behavior are random variables that do not evolve with time (i.e., they are quenched or frozen)—e.g., spin glasses. It is opposite to annealed disorder, where the random variables are allowed to evolve themselves. Embodiments herein include systems comprising quenched disorder.

The alloy described herein can be crystalline, partially crystalline, amorphous, or substantially amorphous. For example, the alloy sample/specimen can include at least some crystallinity, with grains/crystals having sizes in the nanometer and/or micrometer ranges. Alternatively, the alloy can be substantially amorphous, such as fully amorphous. In one embodiment, the alloy composition is at least substantially not amorphous, such as being substantially crystalline, such as being entirely crystalline.

In one embodiment, the presence of a crystal or a plurality of crystals in an otherwise amorphous alloy can be construed as a “crystalline phase” therein. The degree of crystallinity (or “crystallinity” for short in some embodiments) of an alloy can refer to the amount of the crystalline phase present in the alloy. The degree can refer to, for example, a fraction of crystals present in the alloy. The fraction can refer to volume fraction or weight fraction, depending on the context. A measure of how “amorphous” an amorphous alloy is can be amorphicity. Amorphicity can be measured in terms of a degree of crystallinity. For example, in one embodiment, an alloy having a low degree of crystallinity can be said to have a high degree of amorphicity. In one embodiment, for example, an alloy having 60 vol % crystalline phase can have a 40 vol % amorphous phase.

### Amorphous Alloy or Amorphous Metal

An “amorphous alloy” is an alloy having an amorphous content of more than 50% by volume, preferably more than 90% by volume of amorphous content, more preferably more than 95% by volume of amorphous content, and most preferably more than 99% to almost 100% by volume of amorphous content. Note that, as described above, an alloy high in amorphicity is equivalently low in degree of crystallinity. An “amorphous metal” is an amorphous metal material with a disordered atomic-scale structure. In contrast to most metals, which are crystalline and therefore have a highly ordered arrangement of atoms, amorphous alloys are non-crystalline. Materials in which such a disordered structure is produced directly from the liquid state during cooling are sometimes referred to as “glasses.” Accordingly, amorphous metals are commonly referred to as “metallic glasses” or “glassy metals.” In one embodiment, a bulk metallic glass (“BMG”) can refer to an alloy, of which the microstructure is at least partially amorphous. However, there are several ways besides extremely rapid cooling to produce amorphous metals, including physical vapor deposition, solid-state reaction, ion irradiation, melt spinning, and mechanical alloying. Amorphous alloys can be a single class of materials, regardless of how they are prepared.

Amorphous metals can be produced through a variety of quick-cooling methods. For instance, amorphous metals can be produced by sputtering molten metal onto a spinning metal disk. The rapid cooling, on the order of millions of degrees a second, can be too fast for crystals to form, and the material is thus “locked in” a glassy state. Also, amorphous metals/alloys can be produced with critical cooling rates low enough to allow formation of amorphous structures in thick layers—e.g., bulk metallic glasses.

The terms “bulk metallic glass” (“BMG”), bulk amorphous alloy (“BAA”), and bulk solidifying amorphous alloy are used interchangeably herein. They refer to amorphous alloys having the smallest dimension at least in the millimeter range. For example, the dimension can be at least about 0.5 mm, such as at least about 1 mm, such as at least about 2 mm, such as at least about 4 mm, such as at least about 5 mm, such as at least about 6 mm, such as at least about 8 mm, such as at least about 10 mm, such as at least about 12 mm. Depending on the geometry, the dimension can refer to the diameter, radius, thickness, width, length, etc. A BMG can also be a metallic glass having at least one dimension in the centimeter range, such as at least about 1.0 cm, such as at least about 2.0 cm, such as at least about 5.0 cm, such as at least about 10.0 cm. In some embodiments, a BMG can have at least one dimension at least in the meter range. A BMG can take any of the shapes or forms described above, as related to a metallic glass. Accordingly, a BMG described herein in some embodiments can be different from a thin film made by a conventional deposition technique in one important aspect—the former can be of a much larger dimension than the latter.

Amorphous metals can be an alloy rather than a pure metal. The alloys may contain atoms of significantly different sizes, leading to low free volume (and therefore having viscosity up to orders of magnitude higher than other metals and alloys) in a molten state. The viscosity prevents the atoms from moving enough to form an ordered lattice. The material structure may result in low shrinkage during cooling and resistance to plastic deformation. The absence of grain boundaries, the weak spots of crystalline materials in some cases, may, for example, lead to better resistance to wear and corrosion. In one embodiment, amorphous metals, while technically glasses, may also be much tougher and less brittle than oxide glasses and ceramics.

Thermal conductivity of amorphous materials may be lower than that of their crystalline counterparts. To achieve formation of an amorphous structure even during slower cooling, the alloy may be made of three or more components, leading to complex crystal units with higher potential energy and lower probability of formation. The formation of amorphous alloy can depend on several factors: the composition of the components of the alloy; the atomic radius of the components (preferably with a significant difference of over 12% to achieve high packing density and low free volume); and the negative heat of mixing the combination of components, inhibiting crystal nucleation and prolonging the time the molten metal stays in a supercooled state. However, as the formation of an amorphous alloy is based on many different variables, it can be difficult to make a prior determination of whether an alloy composition would form an amorphous alloy.

Amorphous alloys, for example, of boron, silicon, phosphorus, and other glass formers with magnetic metals (iron, cobalt, nickel) may be magnetic, with low coercivity and high electrical resistance. The high resistance leads to low losses by eddy currents when subjected to alternating magnetic fields, a property useful, for example, as transformer magnetic cores.

Amorphous alloys may have a variety of potentially useful properties. In particular, they tend to be stronger than crystalline alloys of similar chemical composition, and they can sustain larger reversible (“elastic”) deformations than crystalline alloys. Amorphous metals derive their strength directly from their non-crystalline structure, which can have none of the defects (such as dislocations) that limit the strength of crystalline alloys. For example, one modern amorphous metal, known as Vitreloy™, has a tensile strength that is almost twice that of high-grade titanium. In some embodiments, metallic glasses at room temperature are not ductile and tend to fail suddenly when loaded in tension, which limits the material applicability in reliability-critical applications, as the impending failure is not evident. Therefore, to overcome this challenge, metal matrix composite materials having a metallic glass matrix containing dendritic particles or fibers of a ductile crystalline metal can be used. Alternatively, a BMG low in element(s) that tend to cause embitterment (e.g., Ni) can be used. For example, a Ni-free BMG can be used to improve the ductility of the BMG.

Another useful property of bulk amorphous alloys is that they can be true glasses; in other words, they can soften and flow upon heating. This can allow for easy processing, such as by injection molding, in much the same way as polymers. As a result, amorphous alloys can be used for making sports equipment, medical devices, electronic components and equipment, and thin films. Thin films of amorphous metals can be deposited as protective coatings via a high velocity oxygen fuel technique.

A material can have an amorphous phase, a crystalline phase, or both. The amorphous and crystalline phases can have the same chemical composition and differ only in the microstructure—i.e., one amorphous and the other crystalline. Microstructure in one embodiment refers to the structure of a material as revealed by a microscope at 25× magnification or higher. Alternatively, the two phases can have different chemical compositions and microstructures. For example, a composition can be partially amorphous, substantially amorphous, or completely amorphous.

As described above, the degree of amorphicity (and conversely the degree of crystallinity) can be measured by fraction of crystals present in the alloy. The degree can refer to volume fraction of weight fraction of the crystalline phase present in the alloy. A partially amorphous composition can refer to a composition of at least about 5 vol % of which is of an amorphous phase, such as at least about 10 vol %, such as at least about 20 vol %, such as at least about 40 vol %, such as at least about 60 vol %, such as at least about 80 vol %, such as at least about 90 vol %. The terms “substantially” and “about” have been defined elsewhere in this application. Accordingly, a composition that is at least substantially amorphous can refer to one of which at least about 90 vol % is amorphous, such as at least about 95 vol %, such as at least about 98 vol %, such as at least about 99 vol %, such as at least about 99.5 vol %, such as at least about 99.8 vol %, such as at least about 99.9 vol %. In one embodiment, a substantially amorphous composition can have some incidental, insignificant amount of crystalline phase present therein.

In one embodiment, an amorphous alloy composition can be homogeneous with respect to the amorphous phase. A substance that is uniform in composition is homogeneous. This is in contrast to a substance that is heterogeneous. The term “composition” refers to the chemical composition and/or microstructure in the substance. A substance is homogeneous when a volume of the substance is divided in half and both halves have substantially the same composition. For example, a particulate suspension is homogeneous when a volume of the particulate suspension is divided in half and both halves have substantially the same volume of particles. However, it might be possible to see the individual particles under a microscope. Another example of a homogeneous substance is air where different ingredients therein are equally suspended, though the particles, gases and liquids in air can be analyzed separately or separated from air.

A composition that is homogeneous with respect to an amorphous alloy can refer to one having an amorphous phase substantially uniformly distributed throughout its microstructure. In other words, the composition macroscopically comprises a substantially uniformly distributed amorphous alloy throughout the composition. In an alternative embodiment, the composition can be of a composite, having an amorphous phase having therein a non-amorphous phase. The non-amorphous phase can be a crystal or a plurality of crystals. The crystals can be in the form of particulates of any shape, such as spherical, ellipsoid, wire-like, rod-like, sheet-like, flake-like, or an irregular shape. In one embodiment, it can have a dendritic form. For example, an at least partially amorphous composite composition can have a crystalline phase in the shape of dendrites dispersed in an amorphous phase matrix; the dispersion can be uniform or non-uniform, and the amorphous phase and the crystalline phase can have the same or a different chemical composition. In one embodiment, they have substantially the same chemical composition. In another embodiment, the crystalline phase can be more ductile than the BMG phase.

The methods described herein can be applicable to any type of amorphous alloy. Similarly, the amorphous alloy described herein as a constituent of a composition or article can be of any type. The amorphous alloy can comprise the element Zr, Hf, Ti, Cu, Ni, Pt, Pd, Fe, Mg, Au, La, Ag, Al, Mo, Nb, Be, or combinations thereof. Namely, the alloy can include any combination of these elements in its chemical formula or chemical composition. The elements can be present at different weight or volume percentages. For example, an iron “based” alloy can refer to an alloy having a non-insignificant weight percentage of iron present therein, the weight percent can be, for example, at least about 20 wt %, such as at least about 40 wt %, such as at least about 50 wt %, such as at least about 60 wt %, such as at least about 80 wt %. Alternatively, in one embodiment, the above-described percentages can be volume percentages, instead of weight percentages. Accordingly, an amorphous alloy can be zirconium-based, titanium-based, platinum-based, palladium-based, gold-based, silver-based, copper-based, iron-based, nickel-based, aluminum-based, molybdenum-based, and the like. The alloy can also be free of any of the aforementioned elements to suit a particular purpose. For example, in some embodiments, the alloy, or the composition including the alloy, can be substantially free of nickel, aluminum, titanium, beryllium, or combinations thereof. In one embodiment, the alloy or the composite is completely free of nickel, aluminum, titanium, beryllium, or combinations thereof.

For example, the amorphous alloy can have the formula (Zr, Ti)ₐ(Ni, Cu, Fe)_{b}(Be, Al, Si, B)_{c}, wherein a, b, and c each represents a weight or atomic percentage. In one embodiment, a is in the range of from 30 to 75, b is in the range of from 5 to 60, and c is in the range of from 0 to 50 in atomic percentages. Alternatively, the amorphous alloy can have the formula (Zr, Ti)ₐ(Ni, Cu)_{b}(Be)_{c}, wherein a, b, and c each represents a weight or atomic percentage. In one embodiment, a is in the range of from 40 to 75, b is in the range of from 5 to 50, and c is in the range of from 5 to 50 in atomic percentages. The alloy can also have the formula (Zr, Ti)ₐ(Ni, Cu)_{b}(Be)_{c}, wherein a, b, and c each represents a weight or atomic percentage. In one embodiment, a is in the range of from 45 to 65, b is in the range of from 7.5 to 35, and c is in the range of from 10 to 37.5 in atomic percentages. Alternatively, the alloy can have the formula (Zr)ₐ(Nb, Ti)_{b}(Ni, Cu)_{c}(Al)_{d}, wherein a, b, c, and d each represents a weight or atomic percentage. In one embodiment, a is in the range of from 45 to 65, b is in the range of from 0 to 10, c is in the range of from 20 to 40 and d is in the range of from 7.5 to 15 in atomic percentages. One exemplary embodiment of the aforedescribed alloy system is a Zr—Ti—Ni—Cu—Be based amorphous alloy under the trade name Vitreloy™, such as Vitreloy-1 and Vitreloy-101, as fabricated by Liquidmetal Technologies, Calif., USA. Some examples of amorphous alloys of the different systems are provided in Table 1.

The amorphous alloys can also be ferrous alloys, such as (Fe, Ni, Co) based alloys. Examples of such compositions are disclosed in U.S. Pat. Nos. 6,325,868; 5,288,344; 5,368,659; 5,618,359; and 5,735,975, Inoue et al., Appl. Phys. Lett., Volume 71, p 464 (1997), Shen et al., Mater. Trans., JIM, Volume 42, p 2136 (2001), and Japanese Patent Application No. 200126277 (Pub. No. 2001303218 A). One exemplary composition is Fe₇₂Al₅Ga₂P₁₁C₆B₄. Another example is Fe₇₂Al₇Zr₁₀Mo₅W₂B₁₅. Another iron-based alloy system that can be used in the coating herein is disclosed in U.S. Patent Application Publication No. 2010/0084052, wherein the amorphous metal contains, for example, manganese (1 to 3 atomic %), yttrium (0.1 to 10 atomic %), and silicon (0.3 to 3.1 atomic %) in the range of composition given in parentheses; and that contains the following elements in the specified range of composition given in parentheses: chromium (15 to 20 atomic %), molybdenum (2 to 15 atomic %), tungsten (1 to 3 atomic %), boron (5 to 16 atomic %), carbon (3 to 16 atomic %), and the balance iron.

The aforedescribed amorphous alloy systems can further include additional elements, such as additional transition metal elements, including Nb, Cr, V, and Co. The additional elements can be present at less than or equal to about 30 wt %, such as less than or equal to about 20 wt %, such as less than or equal to about 10 wt %, such as less than or equal to about 5 wt %. In one embodiment, the additional, optional element is at least one of cobalt, manganese, zirconium, tantalum, niobium, tungsten, yttrium, titanium, vanadium and hafnium to form carbides and further improve wear and corrosion resistance. Further optional elements may include phosphorous, germanium and arsenic, totaling up to about 2%, and preferably less than 1%, to reduce melting point. Otherwise incidental impurities should be less than about 2% and preferably 0.5%.

TABLE 1
Exemplary amorphous alloy compositions

| Alloy | Atm % | Atm % | Atm % | Atm % | Atm % | Atm % |
|---|---|---|---|---|---|---|
| 1 | Zr | Ti | Cu | Ni | Be | |
| | 41.20% | 13.80% | 12.50% | 10.00% | 22.50% | |
| 2 | Zr | Ti | Cu | Ni | Be | |
| | 44.00% | 11.00% | 10.00% | 10.00% | 25.00% | |
| 3 | Zr | Ti | Cu | Ni | Nb | Be |
| | 56.25% | 11.25% | 6.88% | 5.63% | 7.50% | 12.50% |
| 4 | Zr | Ti | Cu | Ni | Al | Be |
| | 64.75% | 5.60% | 14.90% | 11.15% | 2.60% | 1.00% |
| 5 | Zr | Ti | Cu | Ni | Al | |
| | 52.50% | 5.00% | 17.90% | 14.60% | 10.00% | |
| 6 | Zr | Nb | Cu | Ni | Al | |
| | 57.00% | 5.00% | 15.40% | 12.60% | 10.00% | |
| 7 | Zr | Cu | Ni | Al | Sn | |
| | 50.75% | 36.23% | 4.03% | 9.00% | 0.50% | |
| 8 | Zr | Ti | Cu | Ni | Be | |
| | 46.75% | 8.25% | 7.50% | 10.00% | 27.50% | |
| 9 | Zr | Ti | Ni | Be | | |
| | 21.67% | 43.33% | 7.50% | 27.50% | | |
| 10 | Zr | Ti | Cu | Be | | |
| | 35.00% | 30.00% | 7.50% | 27.50% | | |
| 11 | Zr | Ti | Co | Be | | |
| | 35.00% | 30.00% | 6.00% | 29.00% | | |
| 12 | Au | Ag | Pd | Cu | Si | |
| | 49.00% | 5.50% | 2.30% | 26.90% | 16.30% | |
| 13 | Au | Ag | Pd | Cu | Si | |
| | 50.90% | 3.00% | 2.30% | 27.80% | 16.00% | |
| 14 | Pt | Cu | Ni | P | | |
| | 57.50% | 14.70% | 5.30% | 22.50% | | |
| 15 | Zr | Ti | Nb | Cu | Be | |
| | 36.60% | 31.40% | 7.00% | 5.90% | 19.10% | |
| 16 | Zr | Ti | Nb | Cu | Be | |
| | 38.30% | 32.90% | 7.30% | 6.20% | 15.30% | |
| 17 | Zr | Ti | Nb | Cu | Be | |
| | 39.60% | 33.90% | 7.60% | 6.40% | 12.50% | |
| 18 | Cu | Ti | Zr | Ni | | |
| | 47.00% | 34.00% | 11.00% | 8.00% | | |
| 19 | Zr | Co | Al | | | |
| | 55.00% | 25.00% | 20.00% | | | |

Other exemplary ferrous metal-based alloys include compositions such as those disclosed in U.S. Patent Application Publication Nos. 2007/0079907 and 2008/0118387. These compositions include the Fe(Mn, Co, Ni, Cu) (C, Si, B, P, Al) system, wherein the Fe content is from 60 to 75 atomic percentage, the total of (Mn, Co, Ni, Cu) is in the range of from 5 to 25 atomic percentage, and the total of (C, Si, B, P, Al) is in the range of from 8 to 20 atomic percentage, as well as the exemplary composition Fe₄₈Cr₁₅Mo₁₄Y₂C₁₅B₆. They also include the alloy systems described by Fe—Cr—Mo—(Y,Ln)—C—B, Co—Cr—Mo—Ln—C—B, Fe—Mn—Cr—Mo—(Y,Ln)—C—B, (Fe, Cr, Co)—(Mo,Mn)—(C,B)—Y, Fe—(Co,Ni)—(Zr,Nb,Ta)—(Mo,W)—B, Fe—(Al,Ga)—(P,C,B,Si,Ge), Fe—(Co, Cr,Mo,Ga,Sb)—P—B—C, (Fe, Co)—B—Si—Nb alloys, and Fe—(Cr—Mo)—(C,B)—Tm, where Ln denotes a lanthanide element and Tm denotes a transition metal element. Furthermore, the amorphous alloy can also be one of the exemplary compositions Fe₈₀P_{12.5}C₅B_{2.5}, Fe₈₀P₁₁C₅B_{2.5}Si_{1.5}, Fe_{74.5}Mo_{5.5}P_{12.5}C₅B_{2.5}, Fe_{74.5}Mo_{5.5}P₁₁C₅B_{2.5}Si_{1.5}, Fe₇₀Mo₅Ni₅P_{12.5}C₅B_{2.5}, Fe₇₀Mo₅Ni₅P₁₁C₅B_{2.5}Si_{1.5}, Fe₆₈Mo₅Ni₅Cr₂P_{12.5}C₅B_{2.5}, and Fe₆₈Mo₅Ni₅Cr₂P₁₁C₅B_{2.5}Si_{1.5}, described in U.S. Patent Application Publication No. 2010/0300148. Some additional examples of amorphous alloys of different systems are provided in Table 2.

TABLE 2
Exemplary amorphous alloy compositions

| Alloy | Atm % | Atm % | Atm % | Atm % | Atm % | Atm % | Atm % | Atm % |
|---|---|---|---|---|---|---|---|---|
| 1 | Fe | Mo | Ni | Cr | P | C | B | |
| | 68.00% | 5.00% | 5.00% | 2.00% | 12.50% | 5.00% | 2.50% | |
| 2 | Fe | Mo | Ni | Cr | P | C | B | Si |
| | 68.00% | 5.00% | 5.00% | 2.00% | 11.00% | 5.00% | 2.50% | 1.50% |
| 3 | Pd | Cu | Co | P | | | | |
| | 44.48% | 32.35% | 4.05% | 19.11% | | | | |
| 4 | Pd | Ag | Si | P | | | | |
| | 77.50% | 6.00% | 9.00% | 7.50% | | | | |
| 5 | Pd | Ag | Si | P | Ge | | | |
| | 79.00% | 3.50% | 9.50% | 6.00% | 2.00% | | | |
| 6 | Pt | Cu | Ag | P | B | Si | | |
| | 74.70% | 1.50% | 0.30% | 18.0% | 4.00% | 1.50% | | |

In some embodiments, a composition having an amorphous alloy can include a small amount of impurities. The impurity elements can be intentionally added to modify the properties of the composition, such as improving the mechanical properties (e.g., hardness, strength, fracture mechanism, etc.) and/or improving the corrosion resistance. Alternatively, the impurities can be present as inevitable, incidental impurities, such as those obtained as a byproduct of processing and manufacturing. The impurities can be less than or equal to about 10 wt %, such as about 5 wt %, such as about 2 wt %, such as about 1 wt %, such as about 0.5 wt %, such as about 0.1 wt %. In some embodiments, these percentages can be volume percentages instead of weight percentages. In one embodiment, the alloy sample/composition consists essentially of the amorphous alloy (with only a small incidental amount of impurities). In another embodiment, the composition includes the amorphous alloy (with no observable trace of impurities).

In one embodiment, the final parts exceeded the critical casting thickness of the bulk solidifying amorphous alloys.

In embodiments herein, the existence of a supercooled liquid region in which the bulk-solidifying amorphous alloy can exist as a high viscous liquid allows for superplastic forming. Large plastic deformations can be obtained. The ability to undergo large plastic deformation in the supercooled liquid region is used for the forming and/or cutting process. As oppose to solids, the liquid bulk solidifying alloy deforms locally which drastically lowers the required energy for cutting and forming. The ease of cutting and forming depends on the temperature of the alloy, the mold, and the cutting tool. As higher is the temperature, the lower is the viscosity, and consequently easier is the cutting and forming.

Embodiments herein can utilize a thermoplastic-forming process with amorphous alloys carried out between Tg and Tx, for example. Herein, Tx and Tg are determined from standard DSC measurements at typical heating rates (e.g. 20° C./min) as the onset of crystallization temperature and the onset of glass transition temperature.

The amorphous alloy components can have the critical casting thickness and the final part can have thickness that is thicker than the critical casting thickness. Moreover, the time and temperature of the heating and shaping operation is selected such that the elastic strain limit of the amorphous alloy could be substantially preserved to be not less than 1.0%, and preferably not being less than 1.5%. In the context of the embodiments herein, temperatures around glass transition means the forming temperatures can be below glass transition, at or around glass transition, and above glass transition temperature, but preferably at temperatures below the crystallization temperature T_{X}. The cooling step is carried out at rates similar to the heating rates at the heating step, and preferably at rates greater than the heating rates at the heating step. The cooling step is also achieved preferably while the forming and shaping loads are still maintained.

### Electronic Devices

The embodiments herein can be valuable in the fabrication of electronic devices, circuits, or components using a BMG. An electronic device herein can refer to any electronic device known in the art. For example, it can be a telephone, such as a cell phone, and a land-line phone, or any communication device, such as a smart phone, including, for example an iPhone®, and an electronic email sending/receiving device. It can be a part of a display, such as a digital display, a TV monitor, an electronic-book reader, a portable web-browser (e.g., iPad®), and a computer monitor. It can also be an entertainment device, including a portable DVD player, conventional DVD player, Blue-Ray® disk player, video game console, music player, such as a portable music player (e.g., iPod®), etc. It can also be a part of a device that provides control, such as controlling the streaming of images, videos, sounds (e.g., Apple TV®), or it can be a remote control for an electronic device. It can be a part of a computer or its accessories, such as the hard drive tower housing or casing, laptop housing, laptop keyboard, laptop track pad, desktop keyboard, mouse, and speaker. The article can also be applied to a device such as a watch or a clock.

### Illustrative Embodiments

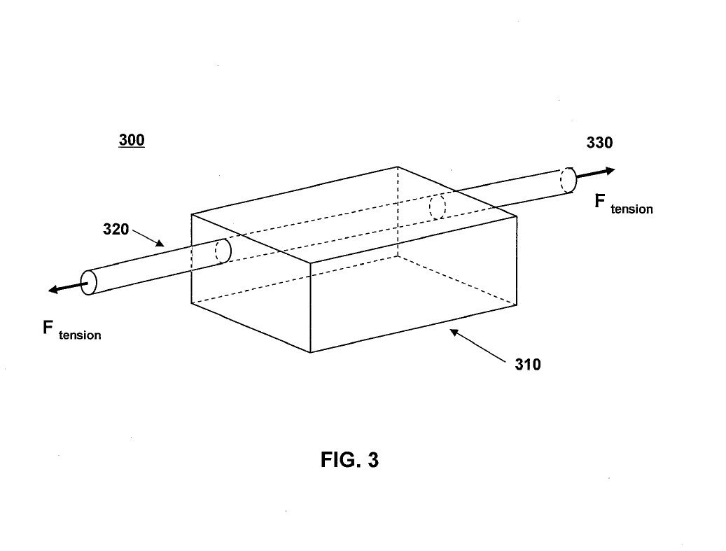

Turning now to FIG. 3, an embodiment of composite structure 300 includes bulk material 310 which has an intrinsic strain-to-failure rating in tension. Bulk material 310 may be a bulk amorphous alloy (BAA), or other bulk material such as silica, ceramic, or plastic material, or a crystalline form of one or more metals or alloys of aluminum, bismuth, cobalt, copper, gallium, gold, indium, iron, lead, magnesium, mercury, nickel, potassium, plutonium, rare earth alloys, rhodium, silver, titanium, tin, uranium, zinc, zirconium, and mixtures thereof. The phrase “bulk material” as used in this disclosure is understood to mean any of the above materials and/or alloys thereof, except when described as being a particular material. The bulk material may be considered and referred to as a “matrix material.”

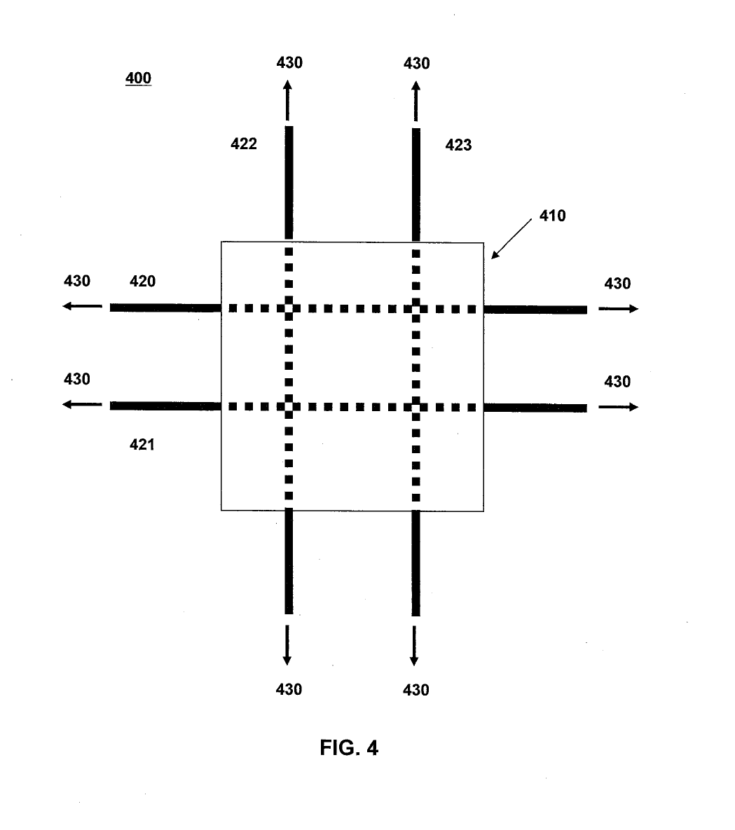

Similar to concrete structures, bulk materials, and bulk amorphous alloys in particular generally have better structural performance in compression than in tension. Reinforcing material 320 (e.g., a fiber or wire) may be embedded in bulk material 310 along a first direction, e.g., along the length of bulk material 310. Reinforcing material may also be embedded in other directions within bulk material 310, for example, perpendicular to the length of bulk material 310, i.e., across the width of bulk material 310, as illustrated in FIG. 4, or in other directions (not shown). FIG. 4 illustrates an embodiment of composite structure 400 with bulk material 410 that has multiple reinforcing material (e.g., embedded fibers/wires 420/421/422/423) therein. These fibers/wires may be metal wires, e.g., ductile wires, or BAA fibers in various embodiments suited for various applications. Fibers/wires 420/421/422/423 may be considered and referred to in all embodiments as “reinforcing material.”

In either embodiment, reinforcing material 320 (or fibers/wires 420, 421, 422, 423) are selected and arranged so as to interact with bulk material 310/410 so as to place composite structures 300/400 into a compressive state at least along the first direction. The resulting compressive state of composite structure 300/400 provides an increased strain-to-failure rating in tension of composite structure 300 along the first direction (and/or other directions for composite structure 400) that is greater than the intrinsic strain-to-failure rating in tension of bulk material 310/410 in the same direction.

To aid in this regard, reinforcing material 320 may be embedded in bulk material 310 with pre-tensioned force 330 (e.g., Fₜₑₙₛᵢₒₙ) acting along the first direction so as to further enhance and/or enable achieving the compressive state for composite structure 300. Reinforcing material 320 may be, for example, a ductile fiber or wire, or a BAA fiber, which may be pre-tensioned. In addition, reinforcing material 320 may have a pattern on an exterior portion thereof, e.g., on an exterior portion of a fiber or wire. The pattern is selected to cooperate with bulk material 310 so as to provide the increased strain-to-failure rating in tension of composite structure 300. Similarly for the embodiment of FIG. 4, one or more fibers/wires 420/421/422/423 may be placed under tension with force 430 (e.g., Fₜₑₙₛᵢₒₙ) acting along the length of each fiber/wire.

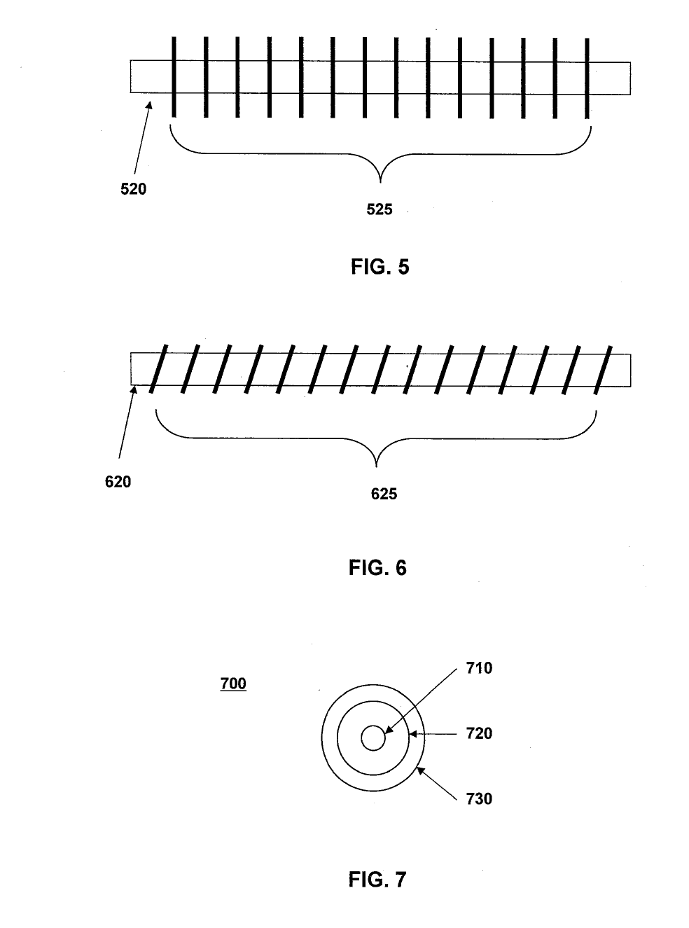

In this regard, and as illustrated in the embodiments of FIGS. 5 and 6, fibers/wires 520/620 may have a pattern (525/625) on an exterior portion of fiber/wire 520/620 to aid in providing a greater force interaction between fiber/wire 320/420/421/422/423 and bulk material 310/410. Such patterns 525/625 are arranged to cooperate with bulk material 310/410 so as to provide the increased strain-to-failure rating in tension of composite structure 300/400. For example, the pattern may be a series of ridges 525 arranged around a circumference of fiber or wire 520 and along its length. When cooling, the bulk material will fill in the areas between ridges 525, which will provide a “gripping force” between the wire and bulk material. Alternatively, the pattern may be a helical pattern 625 along a length of fiber or wire 620. In one embodiment, fiber/wire 320/420/520/620 may be an electrical conductor through which an electrical current flows. Other patterns may be used.

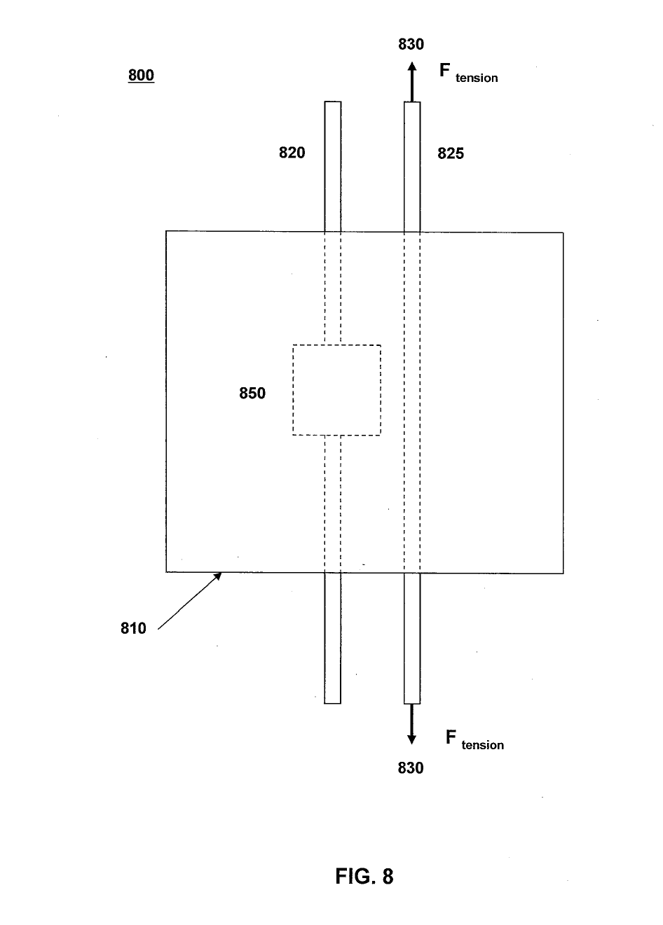

In another aspect of this embodiment, and as illustrated in FIG. 8, composite structure 800 includes bulk material 810, which has fiber/wires 820/825 embedded therein. Electronic circuit 850 may also be embedded in bulk material 810, and at least conductive wire 820 may be operatively coupled to embedded electronic circuit 850 to provide electrical power and/or a data signal to electronic circuit 850. Further, at least fiber/wire 825 may be pre-tensioned with force 830 (e.g., Fₜₑₙₛᵢₒₙ) to place composite structure 800 in the compressive state. Conductive wire 820 (coupled to embedded electronic device 850) may also be pre-tensioned if appropriate safeguards with respect to maintaining an adequate electrical connection to electronic device 850 are observed.

In an alternative embodiment, fiber/wire 820 may be an optical fiber such a optical fiber 700 (see FIG. 7) through which an optical signal travels, and which is optically coupled to embedded electronic circuit 850, and which may be an opto-electronic circuit. Optical fiber 700 may be a single or multi-mode fiber that includes core 710, cladding 720, and exterior sheathing or protective covering 730. An optical signal, e.g., a modulated laser, diode, or other light signal, may be operatively coupled to the optical fiber which, in turn, provides the optical signal to the embedded opto-electronic device.

Returning to the embodiment of FIG. 4, composite structure 400 includes plurality of reinforcing material (e.g., fibers or wires 420/421/422/423) embedded in bulk material 400. Two or more fibers or wires may be embedded in bulk material 410 and pre-tensioned by force 430 along one direction, and/or two or more other fibers or wires may be pre-tensioned along a different direction to place composite structure 400 into the compressive state in one or more directions. The compressive state may be in directions that are perpendicular to each other. More than two wires/fibers or reinforcing materials may be present in each direction.

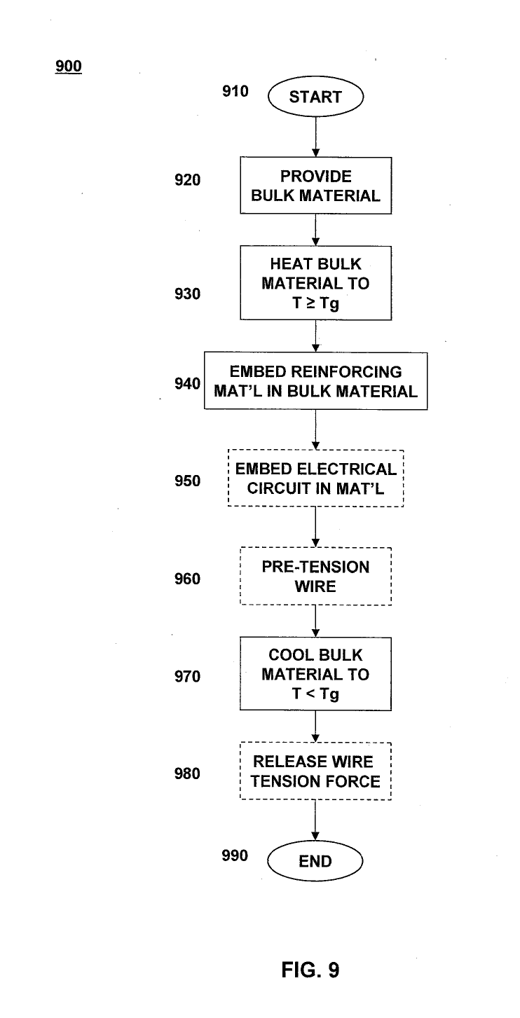

In an embodiment illustrated by the process flow diagram of FIG. 9, method 900 for manufacturing a composite structure starts at step 910, and includes providing a bulk material, e.g., a bulk amorphous alloy, having an associated intrinsic strain-to-failure rating in tension at step 920. In step 930, the bulk material is heated to at least a glass transition temperature (T_{g}) of the bulk material. At step 940, and after heating, reinforcing material may be embedded in the bulk material along a first direction. At step 970, the bulk material is cooled to a temperature less than T_{g}. Thus, after cooling in step 970, the composite structure is then in a compressive state along the direction of the reinforcing material, (e.g., an embedded fiber or wire). As mentioned above, the compressive state of the composite structure provides an increased strain-to-failure rating in tension that is greater than the intrinsic strain-to-failure rating in tension of the bulk material.

Optional steps in process 900 are represented by the dashed boxes in FIG. 9 for steps 950, 960, and 980. In step 950, an optional electrical circuit may also be embedded in the bulk material. The embedded electrical circuit may be operatively coupled to one or more embedded fibers or wires. In addition, the reinforcing material may be pre-tensioned with a force at optional step 960. If pre-tensioning is used, then the pre-tension force should then be released at step 980 after the composite structure is cooled at step 970. Use of such a pre-tensioning force along the reinforcing material (e.g., fiber or wire) length enables and/or enhances the force interaction between the embedded reinforcing material and the bulk material to achieve the compressive state of the composite structure.

Other optional manufacturing steps (not shown), but discussed above with respect to FIGS. 5 and 6 include patterning a fiber or wire on an exterior portion prior to embedding. Such patterning, e.g., a series of ridges or a helical pattern on the fiber/wire, cooperates with the bulk material so as to provide the increased strain-to-failure rating in tension of the composite structure. Other patterns may be used.

As mentioned above, the reinforcing material (e.g., a fiber or wire) may be an electrical conductor through which an electrical current flows through the bulk material, or to an embedded electronic device therein.

As also mentioned above, a plurality of reinforcing materials (e.g., fibers or wires) may be embedded in the bulk material, e.g., a bulk amorphous alloy. Two or more fibers or wires may be embedded along the first direction and pre-tensioned, and one or more fibers or wires may be embedded in the bulk material along a second direction different from the first direction so as to also place the composite structure into the compressive state along both the first and the second directions, e.g., across both the width and length of the composite structure. The fibers or wires may be ductile wires.

The above-discussed embodiments and aspects of this disclosure are not intended to be limiting, but have been shown and described for the purposes of illustrating the functional and structural principles of the inventive concept, and are intended to encompass various modifications that would be within the spirit and scope of the following claims.

What is claimed is:

1. A composite structure, comprising:
a matrix material having an intrinsic strain-to-failure rating in tension associated therewith; and
a reinforcing material embedded in the bulk material along a first direction, wherein the reinforcing material is pre-stressed in tension by a tensile force acting along the first direction;
said pre-stressed embedded reinforcing material interacting with said matrix material so as to place said composite structure into a compressive state along said first direction, said compressive state providing an increased strain-to-failure rating in tension of the composite structure along the first direction that is greater than the intrinsic strain-to-failure rating in tension of the matrix material along the first direction,
wherein at least one of the matrix material and the reinforcing material comprises a bulk amorphous alloy (BAA).

2. The composite structure of claim 1, wherein the matrix material comprises the BAA and the pre-stressed embedded reinforcing material comprises a pre-stressed-ductile fiber or wire embedded in the BAA.

3. The composite structure of claim 1, wherein the matrix material comprises a bulk material and the pre-stressed embedded reinforcing material comprises the BAA shaped as a fiber or wire embedded in the matrix material.

4. The composite structure of claim 3, wherein the bulk material is selected from the group consisting of silica, ceramic, and a plastic material.

5. The composite structure of claim 3, wherein the bulk material comprises a crystalline form of one or more metals or alloys of aluminum, bismuth, cobalt, copper, gallium, gold, indium, iron, lead, magnesium, mercury, nickel, potassium, plutonium, rare earth alloys, rhodium, silver, titanium, tin, uranium, zinc, zirconium, and mixtures thereof.

6. The composite structure of claim 1, wherein said reinforcing material comprises a pattern on an exterior portion of said reinforcing material, said pattern cooperating with said matrix material so as to provide the increased strain-to-failure rating in tension of the composite structure.

7. The composite structure of claim 6, wherein said pattern comprises a helical pattern along a length of a fiber or wire.

8. The composite structure of claim 6, wherein said pattern comprises a series of ridges around a circumference of a fiber or wire and along a length thereof.

9. The composite structure of claim 1, wherein said reinforcing material comprises an electrical conductor through which an electrical current flows.

10. The composite structure of claim 9, further comprising an electrical device embedded in the matrix material, wherein the electrical conductor provides the electrical current through the composite structure to the electrical device.

11. The composite structure of claim 9, wherein the electrical current comprises a data signal.

12. The composite structure of claim 1, wherein said reinforcing material comprises an optical fiber through which an optical signal travels.

13. The composite structure of claim 12, further comprising an electrical device embedded in the matrix material and operatively coupled to the optical fiber, wherein said optical fiber provides the optical signal to the embedded device.

14. The composite structure of claim 1, wherein the reinforcing material comprises a plurality of fibers or wires embedded in the matrix material, wherein two or more fibers or wires of the plurality of fibers or wires are embedded in the matrix material along the first direction, and wherein the two or more fibers or wires are pre-tensioned along the first direction so as to place said composite structure into the compressive state.

15. The composite structure of claim 1, further comprising a second reinforcing material embedded in the matrix material along a second direction different from the first direction so as to also place said composite structure into the compressive state along the second direction.

16. The composite structure of claim 15, wherein said second direction is generally perpendicular to the first direction.

17. A method for manufacturing a composite structure, the method comprising:
providing a matrix material having an intrinsic strain-to-failure rating in tension associated therewith;
heating the matrix material to at least a glass transition temperature (T_{g}) thereof;
after said heating, embedding reinforcing material in the matrix material along a first direction;
providing a tensioning force along the first direction to ends of the reinforcing material so as to place the reinforcing material in tension and thereby enable an interaction between said reinforcing material and said matrix material;
cooling the matrix material to a temperature less than T_{g};
after said cooling, releasing the tensioning force and thereby placing the composite structure into a compressive state along said first direction by the interaction between said reinforcing material and said matrix material,
said compressive state providing an increased strain-to-failure rating in tension of the composite structure along the first direction that is greater than the intrinsic strain-to-failure rating in tension of the matrix material along the first direction, wherein at least one of said matrix material and said reinforcing material comprise a bulk amorphous alloy (BAA).

19. The method of claim 17, wherein the matrix material comprises the BAA and the embedded reinforcing material comprises a ductile fiber or wire embedded in the BAA.

20. The method of claim 17, wherein the matrix material comprises a bulk material and the pre-stressed embedded reinforcing material comprises the BAA shaped as a fiber or wire embedded in the matrix material.

21. The method of claim 15, wherein the bulk material is selected from the group consisting of silica, ceramic, and a plastic material.

22. The method of claim 15, wherein the bulk material comprises a crystalline form of one or more metals or alloys of aluminum, bismuth, cobalt, copper, gallium, gold, indium, iron, lead, magnesium, mercury, nickel, potassium, plutonium, rare earth alloys, rhodium, silver, titanium, tin, uranium, zinc, zirconium, and mixtures thereof

23. The method of claim 17, further comprising patterning said reinforcing material on an exterior portion of said reinforcing material prior to said embedding, said patterning pattern cooperating with said matrix material so as to provide the increased strain-to-failure rating in tension of the composite structure.

24. The method of claim 23, wherein said patterning comprises forming a helical pattern along a length of a fiber or wire.

25. The method of claim 23, wherein said patterning comprises forming a series of ridges around a circumference of a fiber or wire and along a length thereof

26. The method of claim 17, wherein said reinforcing material comprises an electrical conductor through which an electrical current flows, wherein the method further comprises:
embedding an electrical device in the matrix material;
coupling the electrical conductor to the electrical device; and
passing the electrical current through the electrical conductor to the electrical device.

27. The method of claim 17, wherein said reinforcing material comprises an optical fiber through which an optical signal travels, wherein the method further comprises:
embedding an electrical device in the matrix material;
coupling the optical fiber to the electrical device; and
providing the optical signal through the optical fiber to the electrical device.

28. The method of claim 17, further comprising embedding a plurality of fibers or wires in the matrix material, wherein two or more fibers or wires of the plurality of fibers or wires are embedded in the matrix material along the first direction, and wherein the two or more fibers or wires are pre-tensioned along the first direction so as to place said composite structure into the compressive state.

29. The method of claim 17, further comprising embedding a second reinforcing material in the matrix material along a second direction different from the first direction so as to also place said composite structure into the compressive state along the second direction.
